(19) United States
(12) Patent Application Publication
(10) Pub. No.: US 2016/0121509 A1
(43) Pub. Date: May 5, 2016

(54) CORDLESS CIRCULAR SAW

(71) Applicant: HITACHI KOKI CO., LTD., Minato-ku, Tokyo (JP)

(72) Inventor: Shinji Kuragano, Ibaraki (JP)

(73) Assignee: HITACHI KOKI CO., LTD., Minato-ku, Tokyo (JP)

(21) Appl. No.: 14/892,921

(22) PCT Filed: May 21, 2014
(86) PCT No.: PCT/JP2014/064043

§ 371 Date: Nov. 20, 2015

(30) Foreign Application Priority Data
May 30, 2013 (JP) 2013-113688

(51) Int. Cl. B27B 9/02; B25F 5/00

(52) U.S. Cl. CPC B27B 9/02; B25F 5/00

(57) ABSTRACT

A cordless circular saw includes a handle portion, a rechargeable battery which is removably attached to a battery attaching portion provided at the handle portion, a brushless motor which operates by electric power from the rechargeable battery, a control circuit board which has a controller for the brushless motor, a circular saw blade which is rotated by the brushless motor, and a gear cover which accommodates a mechanism for transmitting rotation between the brushless motor and the circular saw blade. The brushless motor is provided on one side of a left side and a right side of the handle portion. The gear cover and the circular saw blade are provided on the other side of the handle portion. The rechargeable battery extends from the handle portion toward the one side of the handle portion. The control circuit board is provided between the rechargeable battery and the circular saw blade.

### TECHNICAL FIELD

The present invention relates to a cordless circular saw having a brushless motor as a driving source.

### BACKGROUND ART

In general, a circular saw has a structure in which a main body having a built-in electric motor is connected on a base, and makes a circular saw blade project from the bottom of the base by a predetermined amount, and rotates the circular saw blade by the electric motor, and uses the circular saw blade to process a workpiece set on the bottom side of the base (for example, JP-A-2012-213829). Recently, it has been considered to use a brushless motor for a circular saw. A brushless motor does not have a brush which is a sliding member, and thus has an advantage that it is unnecessary to check or replace a brush.

### SUMMARY OF INVENTION

### Technical Problem

A circular saw having a brushless motor as a driving source has a motor length shorter than that of a circular saw having a motor with a brush as a driving source, and thus it is possible to reduce the full width of the product. However, structurally, the gear cover side of the circular saw tends to become heavier. For this reason, if the driving source of the circular saw is changed from a motor with a brush to a brushless motor, the motor weight decreases, and thus there is a problem that a position of a gravity center becomes closer to the gear cover side, so that operability would deteriorate.

The present invention have been made in view of the above circumstances, and an object of the present invention is to provide a cordless circular saw capable of suppressing deterioration of operability attributable to a position of a gravity center close to a gear cover side while having a brushless motor as a driving source. According to an aspect of the present invention, there is provided a cordless circular saw comprising: a handle portion; a rechargeable battery which is removably attached to a battery attaching portion provided at the handle portion; a brushless motor which operates by supply of electric power from the rechargeable battery; a control circuit board which has a controller for the brushless motor; a circular saw blade which is rotated by the brushless motor; and a gear cover which accommodates a mechanism for transmitting rotation between the brushless motor and the circular saw blade. The brushless motor is provided on one side of a left side and a right side of the handle portion. The gear cover and the circular saw blade are provided on the other side of the handle portion. The rechargeable battery extends from the handle portion toward the one side of the handle portion. The control circuit board is provided between the rechargeable battery and the circular saw blade.

According to another aspect of the present invention, there is provided a cordless circular saw comprising: a handle portion; a rechargeable battery which is removably attached to a battery attaching portion provided at the handle portion; a brushless motor which operates by supply of electric power from the rechargeable battery; a control circuit board which has a controller for the brushless motor; a circular saw blade which is rotated by the brushless motor; and a gear cover which accommodates a mechanism for transmitting rotation between the brushless motor and the circular saw blade. The brushless motor is provided on one side of a left side and a right side of the handle portion. The gear cover and the circular saw blade are provided on the other side of the handle portion. The rechargeable battery extends from the handle portion toward the one side. A side surface of the rechargeable battery on a side of the circular saw blade is positioned on the one side with respect to a side surface of the handle portion on the side of the circular saw blade.

According to the above configuration, it is possible to provide a cordless circular saw capable of suppressing deterioration of operability attributable to a position of a gravity center close to the gear cover side while having a brushless motor as a driving source.

### BRIEF DESCRIPTION OF DRAWINGS

In the accompanying drawings:

FIG. 1 is a plan view showing a cordless circular saw according to an embodiment of the present invention;

FIG. 2 is a side view of the cordless circular saw;

FIG. 3 is a rear view of the cordless circular saw;

FIG. 4 is a front view of the cordless circular saw;

FIG. 5 is a first plan view of the cordless circular saw where a portion thereof is shown as a cross-section;

FIG. 6 is a second plan view of the cordless circular saw where another portion is shown as a cross-section;

FIG. 7 is a cross-sectional view taken along a line B-B of FIG. 5;

FIG. 8 is a cross-sectional view taken along a line C-C of FIG. 5; and

FIG. 9 is a cross-sectional view taken along a line A-A of FIG. 1.

### DESCRIPTION OF EMBODIMENT

Hereinafter, embodiments of the present invention will be described with reference to the accompanying drawings. Components, members, and the like shown in the drawings and identical or equivalent to each other are denoted by the same reference symbol and may not be repeatedly described. The embodiments do not limit the invention and are illustrative, and all features to be described in the embodiments, and combinations thereof may not be the essential features of the invention.

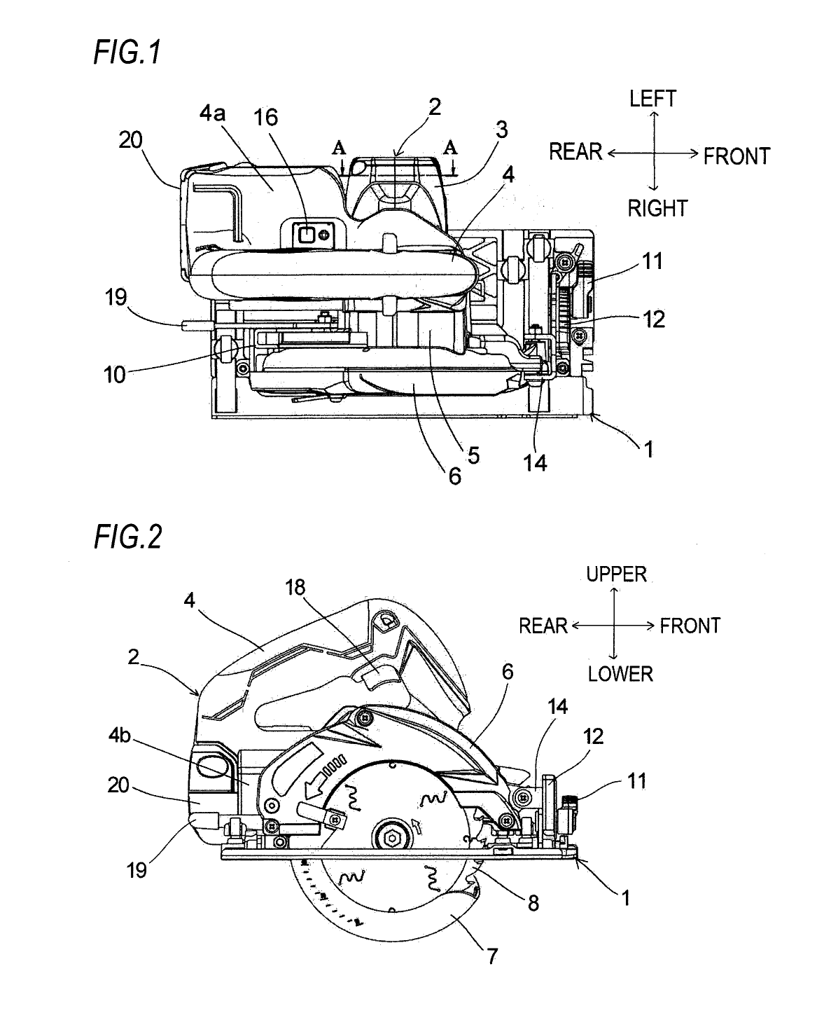

FIGS. 1 to 4 are a plan view, a side view, a rear view, and a front view showing a cordless circular saw according to an embodiment of the present invention, respectively.

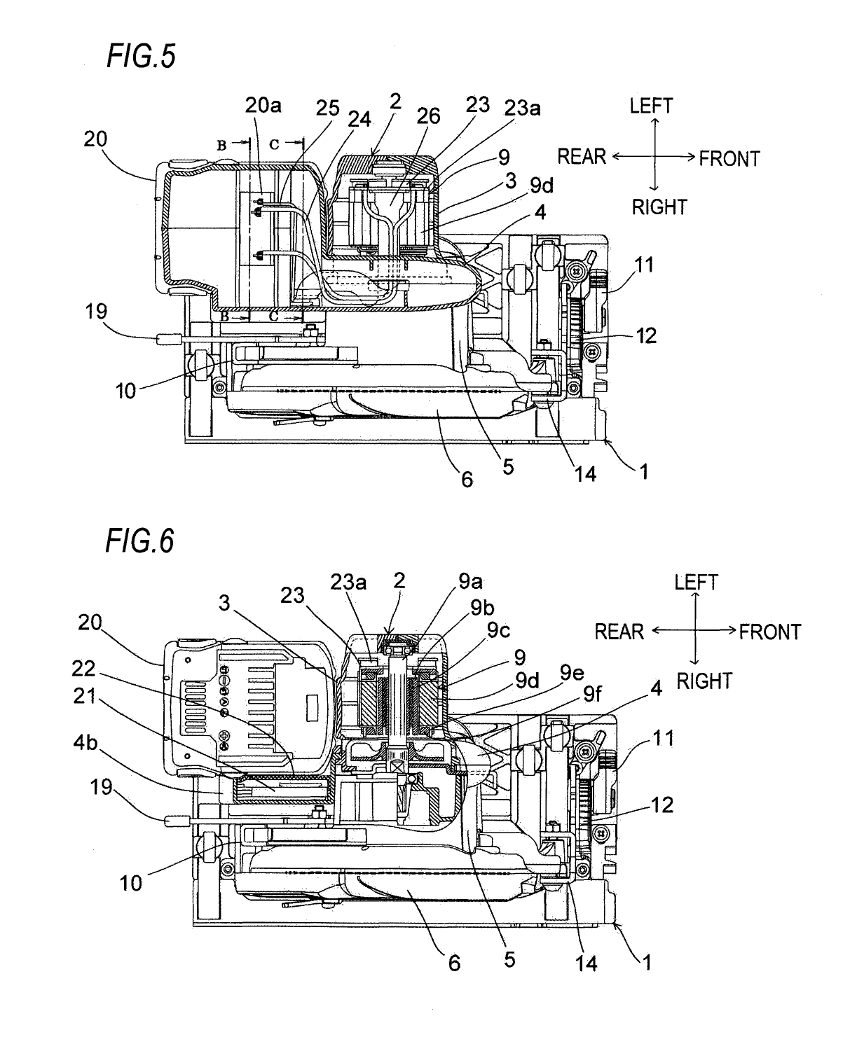

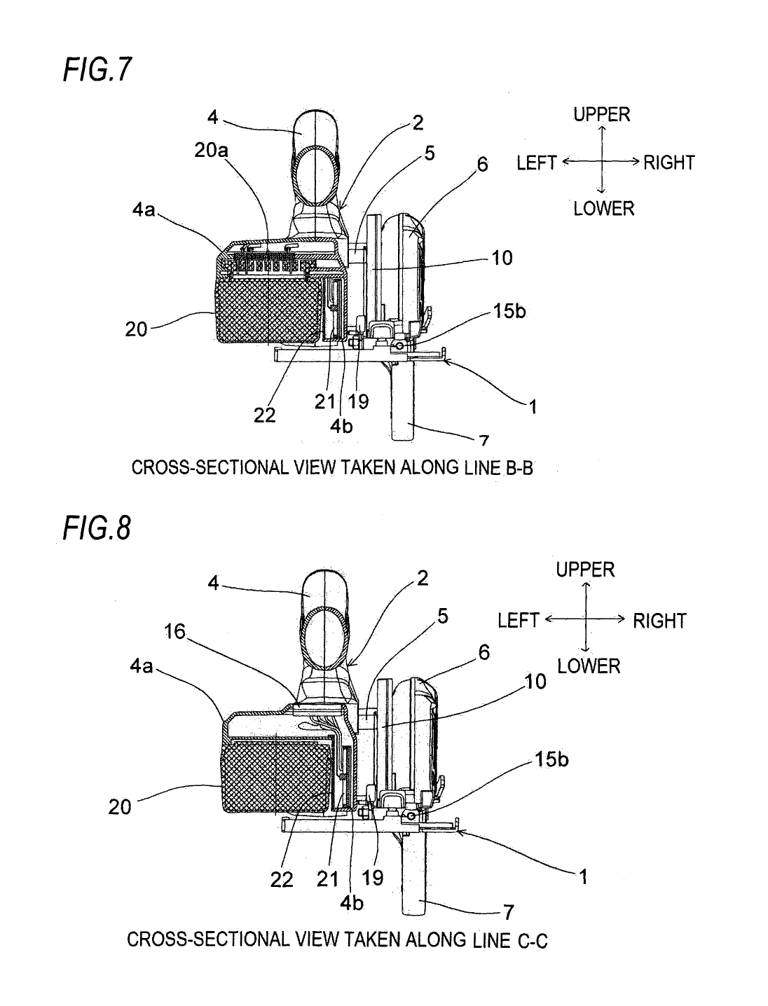

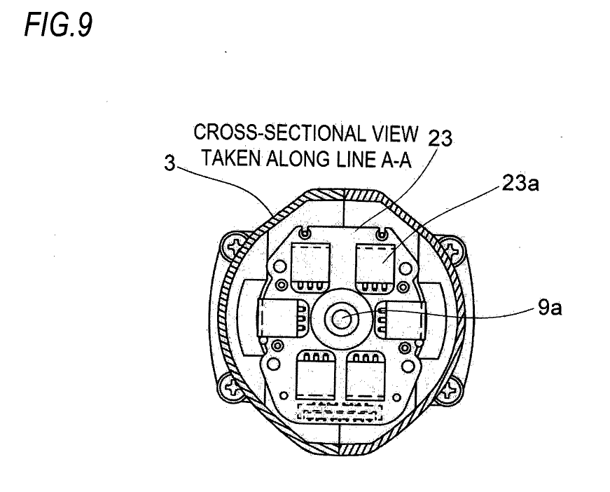

FIG. 5 is a first plan view of the cordless circular saw where a portion thereof is shown as a cross-section. FIG. 6 is a second plan view of the cordless circular saw where another portion thereof is shown as a cross-section. FIG. 7 is a cross-sectional view taken along a line B-B of FIG. 5. FIG. 8 is a cross-sectional view taken along a line C-C of FIG. 5. FIG. 9 is a cross-sectional view taken along a line A-A of FIG. 1.

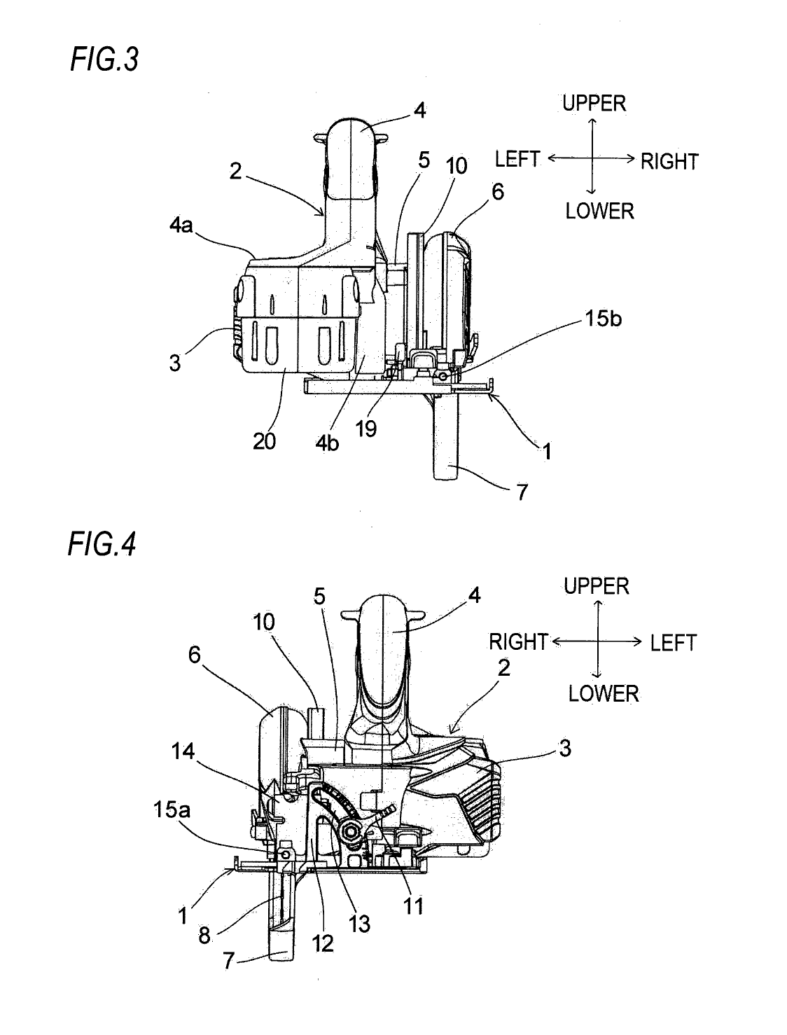

The cordless circular saw of the present embodiment includes a base 1 and a main body 2. The base 1 is a plate material made of a metal such as aluminum substantially in a rectangular shape. The longitudinal direction of the base 1 coincides with a cutting direction. The bottom of the base 1 is a surface to slide on a workpiece. The main body 2 is joined with the base 1 at two positions in a front-rear direction such that the main body can rotate and tilt leftward or rightward with respect to the base 1. The main body 2 includes a motor housing 3, a handle portion 4, a gear cover 5, a saw cover 6, a protective cover 7, and a circular saw blade 8. The motor housing 3 is made of, for example, a resin, and accommodates a brushless motor 9 (FIGS. 5 and 6). The brushless motor 9 rotates the circular saw blade 8. The handle portion 4 is made of the same material as that of the motor housing 3 and integral with the motor housing 3, and extends in the front-rear direction on the motor housing 3. The handle portion 4 includes a switch 18 for allowing a user to control driving of the brushless motor 9. As shown in FIG. 2, the handle portion 4 is configured by a left component provided integrally with the motor housing 3, and a right component interposed between the motor housing 3 and the gear cover 5, and the left component and the right component are combined to configured a battery pack attaching portion 4a (to be described below), and a control circuit board accommodating portion 4b (to be described below) is provided at the right component of the handle portion 4 positioned on a side of the circular saw blade 8. The boundary between the left component and the right component of the handle portion 4 is a line shown at the center of the handle portion 4 in FIG. 1, FIG. 3, FIG. 4, and so on.

At the lower portion of the rear end of the handle portion 4, the battery pack attaching portion 4a (a battery attaching portion) and the control circuit board accommodating portion 4b are integrally provided. A battery pack 20 (a rechargeable battery) is slid into the battery pack attaching portion 4a from the rear side, thereby being removably attached. On the upper surface of the battery pack attaching portion 4a, a tact switch 16 is provided. The battery pack 20 supplies driving power to the brushless motor 9. As shown in FIG. 1, the left surface of the battery pack 20 attached to the battery pack attaching portion 4a, and the left surface of the motor housing 3 exist substantially on the same plane. That is, the distance of the left surface of the motor housing 3 from the circular saw blade 8, and the distance of the left surface of the battery pack 20 from the circular saw blade 8 are substantially the same. Therefore, it is possible to place the cordless circular saw with the left surface of the battery pack 20 and the left surface of the motor housing 3 downward, and to easily perform work for exchanging the circular saw blade 8. The control circuit board accommodating portion 4b is provided on the right side of the battery pack 20. In the control circuit board accommodating portion 4b, a control circuit board 21 is stored and held. The control circuit board 21 has a controller mounted thereon for controlling the operation of the brushless motor 9. The control circuit board 21 is substantially perpendicular to the rotation axis of the brushless motor 9 (the rotation axis of the circular saw blade 8). The control circuit board 21, more specifically, the left side of the control circuit board 21 is partitioned off from the battery pack 20 by a controller cover 22 made of, for example, a resin. The gear cover 5 is provided on the right side of the handle portion 4. The gear cover 5 is made of, for example, a metal, and accommodates a mechanism for transmitting rotation between the brushless motor 9 and the circular saw blade 8. The rotation transmitting mechanism is configured by a known deceleration mechanism. The saw cover 6 is attached to the gear cover 5, and covers the upper half of the circular saw blade 8 in conjunction with the gear cover 5. The saw cover 6 may be formed of the same material as that of the gear cover 5, integrally with the gear cover 5. The front end portions of the gear cover 5 and the saw cover 6 are rotatably joined by a rotation supporting unit 14. The protective cover 7 is made of, for example, a resin, and is rotatably provided along the outer edges of the gear cover 5 and the saw cover 6 on the rear side of the gear cover 5. Between the gear cover 5 and the protective cover 7, a spring (not shown) is interposed. This spring biases the protective cover 7 against the gear cover 5, in a direction (a counterclockwise direction in FIG. 2) for covering the lower half of the circular saw blade 8 in the circumferential direction of the gear cover 5 and the saw cover 6. Therefore, in a state where cutting work is not being performed, the protective cover 7 covers the lower half of the circular saw blade 8 (a portion protruding from the bottom of the base 1), except for a portion of the front side.

On the front side of the base 1, a bevel plate 12 is provided to stand. The bevel plate 12 stands in a short-length direction substantially perpendicular to a cutting direction. The bevel plate 12 has a long hole 13. The long hole 13 has an arc shape having a first tilt shaft portion 15a extending in the cutting direction, as the center, and perpendicular to the first tilt shaft portion 15a. The rotation supporting unit 14 is supported to be able to tilt on the first tilt shaft portion 15a to left or right with respect to the base 1. The tilt position of the rotation supporting unit 14 is adjusted in a state where a tilt-angle adjusting lever 11 is loose, and is fixed by fastening the tilt-angle adjusting lever 11. The rotation supporting unit 14 rotatably supports the front end portion of the saw cover 6 on an axis parallel to the rotation axis of the brushless motor 9 (the rotation axis of the circular saw blade 8). Adjusting and fixing of the rotational position of the saw cover 6 will be described below.

On the rear side of the base 1, a link 10 is provided along the left surface of the gear cover 5 so as to be rotatable around a tilt shaft portion 15b concentric with the first tilt shaft portion 15a. The link 10 is made of a metal such as aluminum. In a state where a cutting-depth adjusting lever 19 is loose, the link 10 and the gear cover 5 are slidable with respect to each other, and thus it is possible to adjust the rotational position of the saw cover 6 with respect to the base 1, that is, the cutting depth. Further, it is possible to fix the rotational position of the gear cover 5 by fastening the cutting-depth adjusting lever 19.

As shown in FIG. 6, the brushless motor 9 has a rotor core 9b around an output shaft 9a. The output shaft 9a is parallel to the rotation axis of the circular saw blade 8. The rotor core 9b rotates integrally with the output shaft 9a. A rotor magnet 9c is inserted into and supported in the rotor core 9b. A stator core 9d is provided to surround the outer circumferential surface of the rotor core 9b. On the stator core 9d, a stator coil 9f is provided with an insulator 9e interposed therebetween. On the left end side of the stator core 9d, a switching board 23 is fixed. The switching board 23 is substantially perpendicular to the output shaft 9a. As shown in FIG. 9, on the switching board 23, six switching devices 23a (such as FETs) are mounted such that their main body portions are laid down. The switching devices 23a switch a supply voltage from the battery pack 20. As shown in FIG. 5, a terminal portion 20a of the battery pack 20, and the switching board 23 are electrically connected to each other by a wiring line 24. A wiring line 25 electrically connects the terminal portion 20a of the battery pack 20 and the control circuit board 21 to each other. A wiring line 26 electrically connects the control circuit board 21 and the switching board 23 to each other. A control signal from the controller of the control circuit board 21 is applied to control terminals (gates) of the switching devices 23a mounted on the switching board 23, by the wiring line 26, whereby ON/OFF of the switching devices 23a is controlled.

The cordless circular saw of this embodiment has the brushless motor 9 as a driving source. Therefore, the motor length is shorter than that in a case of using a motor with a brush as a driving source, and thus it is possible to reduce the full width of the product. However, structurally, a side of the gear cover 5 (the right side of the handle portion 4) of the circular saw tends to be come heavier. For this reason, if the motor weight is reduced by using the brushless motor 9, the right side of the handle portion 4 becomes relatively heavier, and thus there is a problem that the position of the gravity center becomes closer to the right side from the handle portion 4, so that operability would deteriorate. Also, the control circuit board 21 of the brushless motor 9 becomes larger than a control circuit board of a motor with a brush. For this reason, if the control circuit board 21 is disposed on the upper surface of the battery pack 20 or at the upper portion of the inside of the motor housing 3, it is necessary to raise the position of the handle portion 4, which is undesirable restriction on layout. Hereinafter, a configuration for coping with this problem will be described.

As shown in FIG. 1, the gear cover 5 and the circular saw blade 8 are provided on the right side of the handle portion 4. Meanwhile, as shown in FIG. 5, the brushless motor 9 is provided on the left side of the handle portion 4. The center of the battery pack 20 is positioned on the left side with respect to the center of the handle portion 4. Also, the battery pack 20 extends on the left side of the handle portion 4 on the rear side of the handle portion 4. The right surface of the battery pack 20 may be positioned on the left side with respect to the right surface of the handle portion 4. As shown in FIG. 6, the control circuit board 21 is provided between the battery pack 20 and the circular saw blade 8. That is, the control circuit board 21 is disposed in a space between the right surface of the battery pack 20 and the left surface of the saw cover 6 formed by disposing the battery pack 20 relatively on the left side with respect to the handle portion 4. Incidentally, it is preferable that the left surface of the battery pack 20 should not protrude toward the left side from the left surface of the motor housing 3. Therefore, in a mounting manner in which the battery pack 20 is slid into the battery pack attaching portion 4a from the rear side, even if the capacity of the battery pack 20 to be mounted changes, it is possible to dispose the left surface of the battery pack 20 at a predetermined position (the width of the battery pack 20 in a direction perpendicular to the sliding direction is constant regardless of capacity). The cutting-depth adjusting lever 19 is provided between the control circuit board 21 and the circular saw blade 8. Also, the positional relation of each member (such as the gear cover 5, the circular saw blade 8, and the brushless motor 9) with respect to the handle portion 4 in a left-right direction may be reversed.

According to the above configuration, since the battery pack 20 is disposed relatively on the right side with respect to the handle portion 4, it is possible to bring the gravity center, which tends to be on the side of the gear cover 5 (the right side) with respect to the center of the handle portion 4, closer to the center of the handle portion 4. Therefore, it is possible to suppress deterioration of operability attributable to the position of the gravity center close to the side of the gear cover 5 while using the brushless motor 9 as a driving source. Also, since the control circuit board 21 is disposed in the space formed by disposing the battery pack 20 relatively on the left side with respect to the handle portion 4 (the space between the right surface of the battery pack 20 and the left surface of the saw cover 6), it becomes unnecessary to raise the position of the handle portion 4 by use of the brushless motor 9, which is preferable in terms of layout.

Although the invention has been described by reference to the embodiment, it can be understood by those skilled in the art to which the invention pertains that a variety of modifications can be applied to the components and processes of the embodiment without departing from the scope of claims.

For example, in a case where it is allowed to raise the position of the handle portion 4 at design, the control circuit board 21 may be disposed on the upper surface of the battery pack 20 or at the upper portion of the inside of the motor housing 3. In a range in which it is possible to bring the position of the gravity center in the left-right direction sufficiently closer to the center of the handle portion 4, the right surface of the battery pack 20 may extend toward the right side from the right surface of the handle portion 4.

This application claims priority from Japanese Patent Application No. 2013-113688 filed on May 30, 2013, the entire contents of which are incorporated herein by reference.

1. A cordless circular saw comprising:
a handle portion;
a rechargeable battery which is removably attached to a battery attaching portion provided at the handle portion;
a brushless motor which operates by supply of electric power from the rechargeable battery;
a control circuit board which has a controller for the brushless motor;
a circular saw blade which is rotated by the brushless motor; and
a gear cover which accommodates a mechanism for transmitting rotation between the brushless motor and the circular saw blade, wherein:
the brushless motor is provided on one side of a left side and a right side of the handle portion,
the gear cover and the circular saw blade are provided on the other side of the handle portion,
the rechargeable battery extends from the handle portion toward the one side of the handle portion, and
the control circuit board is provided between the rechargeable battery and the circular saw blade.

2. The cordless circular saw according to claim 1,
wherein the control circuit board is disposed to be substantially perpendicularly to a rotation axis of the circular saw blade.

3. The cordless circular saw according to claim 1, further comprising:
a cutting-depth adjusting lever provided between the control circuit board and the circular saw blade.

4. The cordless circular saw according to claim 1,
wherein a side surface of the rechargeable battery on a side of the circular saw blade is positioned on the one side with respect to a side surface of the handle portion on the side of the circular saw blade.

5. The cordless circular saw according to claim 1,
wherein a center of the rechargeable battery is positioned on the one side with respect to a center of the handle portion.

6. The cordless circular saw according to claim 1,
wherein the rechargeable battery is slid to the battery attaching portion from the rear side to be attached.

7. The cordless circular saw according to claim 1, further comprising:
a motor housing which accommodates the brushless motor,
wherein a distance between a side surface of the motor housing on the one side and the circular saw blade is substantially same as a distance of a side surface of the rechargeable battery attached to the battery attaching portion on the one side and the circular saw blade.

8. The cordless circular saw according to claim 1,
wherein a switching board of the brushless motor is disposed on the one side of the brushless motor to be substantially perpendicular to an output shaft of the brushless motor, and a switching device is mounted on the switching board such that a main body portion of the switching device is laid down.

9. A cordless circular saw comprising:
a handle portion;
a rechargeable battery which is removably attached to a battery attaching portion provided at the handle portion;
a brushless motor which operates by supply of electric power from the rechargeable battery;
a control circuit board which has a controller for the brushless motor;
a circular saw blade which is rotated by the brushless motor; and
a gear cover which accommodates a mechanism for transmitting rotation between the brushless motor and the circular saw blade, wherein:
the brushless motor is provided on one side of a left side and a right side of the handle portion,
the gear cover and the circular saw blade are provided on the other side of the handle portion,
the rechargeable battery extends from the handle portion toward the one side, and
a side surface of the rechargeable battery on a side of the circular saw blade is positioned on the one side with respect to a side surface of the handle portion on the side of the circular saw blade.
